(19) United States
(12) Patent Application Publication
(10) Pub. No.: US 2024/0150512 A1
(43) Pub. Date: May 9, 2024

(54) Resin Composition Including Curable Polymer Compound

(71) Applicant: Nippon Kayaku Kabushiki Kaisha, Tokyo (JP)

(72) Inventors: Yasumasa Akatsuka, Tokyo (JP); Shigeo Hayashimoto, Tokyo (JP)

(21) Appl. No.: 18/280,597

(22) PCT Filed: Mar. 4, 2022
(86) PCT No.: PCT/JP2022/009327

§ 371 Date: Sep. 6, 2023

(30) Foreign Application Priority Data
Mar. 9, 2021 (JP) 2021-037073
Jun. 18, 2021 (JP) 2021-101268
Aug. 4, 2021 (JP) 2021-128159

(51) Int. Cl. C08F 267/06; C08J 5/18; C09J 151/00

(52) U.S. Cl. CPC C08F 267/06; C08J 5/18; C09J 151/003; C08J 2351/00

(57) ABSTRACT

The resin composition incudes a polymer compound represented by the formula (1), where in formula (1), R₁ and R₂ each independently represent a hydrogen atom or a methyl group, and m and n represent the average numbers of repeating units, and are each independently in the range between 1 and 2000 inclusive; a compound that can radically polymerize with the polymer compound; and a radical initiator. The compound that can radically polymerize with the polymer compound is at least one selected from the group consisting of phenylmaleimide compounds, acenaphthylene compounds, modified polyphenylene ether resins having an unsaturated double bond at an end, and aryl isocyanurate compounds.

### CROSS REFERENCE TO RELATED APPLICATIONS

This application is the United States national phase of International Patent Application No. PCT/JP2022/009327 filed Mar. 4, 2022, and claims priority to Japanese Patent Application No. 2021-037073 filed Mar. 9, 2021, Japanese Patent Application No. 2021-101268 filed Jun. 18, 2021, and Japanese Patent Application No. 2021-128159 filed Aug. 4, 2021, the disclosures of which are hereby incorporated by reference in their entireties.

### BACKGROUND OF THE INVENTION

### Field of the Invention

The present invention relates to a resin composition containing a curable polymer compound having a specific structure which can be formed into a film easily by casting solution on a base material and is thermally curable or photocurable, and a cured product thereof that is excellent in dielectric property, adhesion, and heat resistance.

### Description of Related Art

A phenoxy resin is a polymer compound having a very large molecular weight and obtained by polymerizing a bifunctional epoxy resin and a bifunctional phenol compound. Because a general epoxy resin composition and a radically polymerizable composition can be formed into a film shape by adding the phenoxy resin, the phenoxy resin is used as an important component of the film adhesive in a wide range of fields. Especially in the electric/electronic field, the phenoxy resin is used for an interlayer insulation layer, a copper foil with resin and the like of the printed wiring board.

The cured product of the resin composition including the phenoxy resin is excellent in adhesion and has the ability to form a film, but has low heat resistance and moreover has a high dielectric constant and a high dielectric loss tangent (generally at the frequency of 1 GHz, the dielectric constant is about 3.5 and the dielectric loss tangent is about 0.03), therefore there is the fact that the phenoxy resin may not be applied to the electronic equipment the response speed of which to the signal is increased recently. As a resin excellent in dielectric properties, the fluorine-containing polymer compounds such as polytetrafluoroethane (PTFE) (Patent Document 1) and the liquid crystal polymer (Patent Document 2) are generally known, but these resins have very low compatibility with other resins and unsatisfactory adhesion. In Patent Document 3, the curable polymer compound obtained by the esterification reaction between the aliphatic hydroxy group of the random copolymer of a monomer equal to or less than 70 wt % having one ethylenically unsaturated group and a (meth)acrylate of equal to or more than 30 wt % having one or more aliphatic hydroxy groups with a monomer having one or more ethylenically unsaturated groups and one carboxy group is described. But, the present inventors conducted the supplementary examination and found that the cured product of the curable polymer compound obtained according to the constitutional formula in Document 3 had a dielectric loss tangent of about 0.005 at 10 GHz and did not satisfy the low dielectric property required for of the recent high-frequency circuit board sufficiently.

### CITATION LIST

### Patent Document

Patent Document 1: JP 2005-001274 A
Patent Document 2: JP 2014-060449 A
Patent Document 3: JP H10-017812 A

### SUMMARY OF THE INVENTION

### Technical Problem

One of the purposes of the present invention is to provide a resin composition the cured product of which has sufficient flexibility to be able to form a film, high adhesion to a low roughness copper foil, low dielectric constant and dielectric loss tangent and a high glass transition temperature.

### Solution to the Problem

It was found to solve the problems by using a resin composition containing a polymer compound having a specific structure, a compound having a specific structure and radically polymerizable with the polymer compound and a radical polymerization initiator so as to finish the present invention.

That is, the present invention relates to:

[1] A resin composition comprising a polymer compound represented by following formula (1):

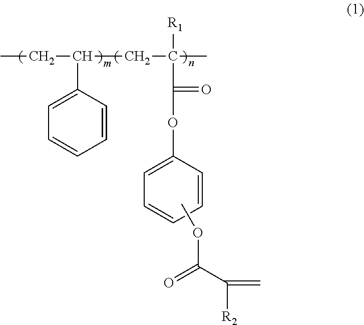

wherein in the formula (1), R₁ and R₂ each independently represent a hydrogen atom or a methyl group, and wherein m and n are average numbers of repeating units and each independently are within a range of 1 to 2,000, a compound radically polymerizable with the polymer compound and a radical polymerization initiator,
wherein the compound radically polymerizable with the polymer compound is at least one selected from a group consisting of a phenylmaleimide compound (A), an acenaphthylene compound (B), a modified polyphenylene ether resin having an unsaturated double bond at an end (C) and an aryl isocyanurate compound (D),
   [2] The resin composition according to item [1], wherein the compound radically polymerizable with the polymer compound is a phenylmaleimide compound having a maleimide group in one molecule or a compound having an acenaphthylene structure in one molecule.
   [3] A film adhesive of the resin composition according to item [1] or [2].
   [4] A cured product of the resin composition according to item [1] or [2] or the film adhesive according to item [3].

### DESCRIPTION OF THE INVENTION

### Effects of the Invention

One of the resin compositions of the present invention can be made into the cured product by applying thermal or photo energy, and the cured product excellent in dielectric property, adhesion and heat resistance can be provided.

### Form to Carry Out Invention

Embodiments of the present invention is described below.

The polymer compound represented by formula (1) and being the essential component of the resin composition of the present invention is the dehydrochlorinated condensate obtained by the reaction of hydroxy group of the random copolymer of hydroxyphenyl(meth)acrylate and styrene with chloride group of (meth)acrylic acid chloride or the dehydrated condensate obtained by the reaction of hydroxy group of the copolymer aforementioned with (meth)acrylic acid.

First, the random copolymer of hydroxyphenyl(meth)acrylate and styrene which is the intermediate raw material of the polymer compound represented by formula (1) (also described simply as “the copolymer” hereinafter) is described.

Examples of hydroxyphenyl(meth)acrylate which is the raw material of the copolymer include 4-hydroxyphenylmethacrylate, 2-hydroxyphenylmethacrylate, 3-hydroxyphenylmethacrylate, 4-hydroxyphenylacrylate, 2-hydroxyphenylacrylate and 3-hydroxyphenylacrylate. 4-hydroxyphenylmethacrylate is preferable.

Note that in this specification, the word “(meth)acrylate” means both of “acrylate and methacrylate”.

The formula (2) described below is the structural formula of the random copolymer of hydroxyphenyl(meth)acrylate and styrene. In formula (2), R₁, m and n are each the same as R₁, m and n in formula (1). Namely, the polymer compound represented by formula (1) (the polymer compound having the structure represented by formula (1)) is a polymer compound obtained from the intermediate raw material which is the copolymer represented by following formula (2).

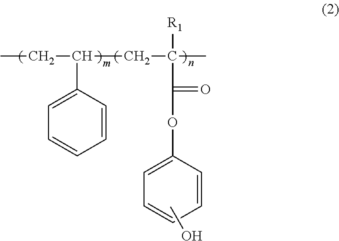

The method of the copolymerization of hydroxyphenyl(meth)acrylate with styrene is not particularly limited as long as the method is known conventionally. Examples include bulk polymerization, solution polymerization, emulsion polymerization and suspension polymerization.

Examples of the solvent usable for solution polymerization include toluene, xylene, methylethylketone, methylisobutylketone, cyclopentanone, cyclohexanone, propyleneglycolmonomethyletheracetate, N-methylpyrrolidone, N,N-dimethylformamide and γ-butyrolactone. Water and surface-active agent are generally used for emulsion polymerization and suspension polymerization. The copolymerization is carried out in the states that the raw material component is emulsified or suspended in water.

The copolymerization reaction may be any one of the radical polymerization, the cation polymerization and the anion polymerization. When the copolymerization reaction is the radical polymerization, the radical polymerization initiator is preferably used. Examples of the radical polymerization initiator include 2,2′-azobisisobutyronitrile, 2,2′-azobis(2-methylbutyronitrile), 2,2′-azobis(2,4-dimethylvaleronitrile), 1,1′-azobis(cyclohexane-1-carbonitrile), 2,2′-azobis[2-(2-imidazoline-2-yl)propane]dihydrochloride, hydrogen peroxide, di-t-butylperoxide, dicumylperoxide and benzoylperoxide.

The blending amount of the radical polymerization initiator is generally 0.001 to 5 parts by mass based on 100 parts by mass of the total amount of the raw material components of the copolymer. The polymerization temperature is generally 50 to 250° C., preferably 60 to 200° C. The polymerization time is generally 0.5 to 30 hours, preferably 1 to 20 hours. The radical polymerization is preferably carried out under nitrogen atmosphere to prevent oxygen in the air from inhibiting the polymerization.

When the copolymerization reaction is the cation polymerization, the cation polymerization initiator can be used. Examples of the cation polymerization initiator include inorganic acids such as sulfuric acid and hydrochloric acid, organic acids such as CF₃COOH and CCl₃COOH and super-strong acids such as CF₃SO₃H and HClO₄.

When the copolymerization reaction is the anion polymerization, the anion polymerization initiator can be used. Examples of the anion polymerization initiator include butyl lithium, Na-naphthalene complex, alkali metal, alkyl lithium compound, sodium amide, Grignard reagent and lithium alkoxide.

The blending amount of the cation polymerization initiator or the anion polymerization initiator is generally 0.01 to 5 parts by mass based on 100 parts by mass of the total amount of the raw material components of the copolymer. The polymerization temperature is generally 40 to 150° C., preferably 50 to 120° C. The polymerization time is generally 0.5 to 20 hours, preferably 1 to 15 hours.

However, because there is concern that the ionic initiator used for the cation polymerization and the anion polymerization remains in the copolymer after polymerization reaction to affect dielectric property and insulation adversely, the copolymer which is the intermediate raw material of the polymer compound represented by formula (1) is preferably synthesized by radical polymerization.

The number-average molecular weight of the copolymer which is the intermediate raw material of the polymer compound represented by formula (1) is generally 3,000 to 300,000, preferably 5,000 to 200,000.

The amount of the initiator is preferably adjusted to the proper amount when synthesizing the copolymer to obtain the copolymer having a number-average molecular weight within the range described above. The amount of the initiator necessary for obtaining the copolymer having a number-average molecular weight within the range described above is not specified generally, because m and n depend on the kinds of (meth)acrylate having a phenolic hydroxy group and the amount of (meth)acrylate having a hydroxy group and styrene used for the copolymerization reaction. However, it is generally known that when the amount of the initiator is reduced, the copolymer having a large molecular weight is obtained. Therefore, the blending amount of the initiator should be selected within the range of the blending amount described above so as to obtain the copolymer having the desired molecular weight.

The use rates of hydroxyphenyl(meth)acrylate and styrene when synthesizing the copolymer which is the intermediate raw material of the polymer compound represented by formula (1) are not particularly limited, but the amount (mass) of styrene is generally 4 to 99.7 times that of hydroxyphenyl(meth)acrylate, preferably 4.5 to 99.5 times that of hydroxyphenyl(meth)acrylate. By using the raw material of the copolymer at the ratio within the range described above, the cured product of the resin composition of the present invention exhibits excellent dielectric properties (low dielectric constant and low dielectric loss tangent).

The polymer compound represented by formula (1) can be obtained by dehydrochlorination reaction of a phenolic hydroxy group of the copolymer aforementioned (this hydroxy group is the hydroxy group of hydroxyphenyl(meth)acrylate which is the raw material) with a chloride group of (meth)acrylic acid chloride or dehydrated condensation reaction of a phenolic hydroxy group of the copolymer aforementioned with (meth)acrylic acid.

The use rates of the copolymer and (meth)acrylic chloride or (meth)acrylic acid when synthesizing the polymer compound represented by formula (1) are not particularly limited. However, because when the rates of (meth)acrylic acid chloride or (meth)acrylic acid is excessive or short compared to the hydroxy group of the copolymer, (meth)acrylic acid chloride or (meth)acrylic acid which remains unreacted or hydroxy group which remains unreacted with (meth)acrylic acid chloride or (meth)acrylic acid in the polymer compound represented by formula (1) may affect various characteristics of the cured product adversely. Therefore, (meth)acrylic acid chloride or (meth)acrylic acid equivalent to hydroxy group of the copolymer is preferably used.

The reaction of the copolymer with (meth)acrylic acid chloride may be carried out by adding (meth)acrylic acid chloride to the organic solvent solution of the copolymer under stirring. The organic solvent used in the reaction is not particularly limited as long as the copolymer and (meth)acrylic acid chloride can be solved in the solvent. When the copolymer which is the intermediate raw material is synthesized in the solvent, the copolymer solution after polymerization reaction can be used as it is. The concentration of the copolymer solution subjected to the reaction with (meth)acrylic acid chloride is generally 10 to 90% by mass, preferably 20 to 80% by mass. The reaction temperature is generally 30 to 120° C., preferably 40 to 110° C. The reaction time is generally 0.5 to 4 hours, preferably 1 to 3 hours.

Because the reaction of the copolymer with (meth)acrylic acid chloride is dehydrochlorination reaction, a tertiary amine such as triethylamine or pyridine is preferably added to the reaction solution in advance to trap hydrochloric acid generated and accelerate the reaction further. The amount of the tertiary amine is preferably from 1 to 4 times molar that of (meth)acrylic acid chloride, more preferably from 1 to 3 times molar that of (meth)acrylic acid chloride. Hydrochloric acid generated during the reaction can be removed by filtrating after the reaction because of deposition as an amine hydrochloride. Excessive tertiary amine can be distilled off from the system under heating and reduced pressure after filtration.

Examples of the reaction of the copolymer with (meth)acrylic acid include conventionally known esterification reaction and examples of the method for carrying out the reaction include the method in which the copolymer and (meth)acrylic acid are heated and stirred under the presence of the catalyst. Because the reaction of the copolymer with (meth)acrylic acid is the dehydration reaction, the reaction is preferably carried out while water is removed from the reaction system by azeotropic distillation. Therefore, the reaction is preferably carried out using the solvents which are not mixed with water completely such as toluene, xylene, ethyl acetate, butyl acetate and methylisobutylketone. The amount of the solvent is preferably decided so that the concentration of the raw material of the polymer compound represented by formula (1) is 20 to 80% by mass.

Examples of the catalyst used for esterification reaction include acid catalyst such as sulfuric acid, methanesulfonic acid and p-toluenesulfonic acid. The amount used is preferably 0.1 to 5% by mass based on the total mass of the raw material of the polymer compound represented by formula (1), solvent and the like used for the reaction. The reaction temperature is generally 50 to 150° C., preferably 60 to 140° C. The reaction time is generally 0.5 to 4 hours, preferably 1 to 3 hours.

To prevent polymerization reaction of (meth)acryloyl groups with each other in the polymer compound represented by formula (1) and improve the storage stability of the polymer compound represented by formula (1) a small amount of polymerization inhibitor is preferably added to the polymer compound solution, after the synthetic reaction is finished. Examples of the polymerization inhibitor include hydroquinone, paramethoxyphenol, methylhydroquinone, di-t-butylhydroxytoluene, t-butylhydroquinone, 2-t-butyl-1,4-benzoquinone, 1,4-benzoquinone, 1,1-diphenyl-2-picrylhydrazyl free radical, 6-t-butyl-2,4-xylenol, 4-t-butylpyrocatechol, 2,6-di-t-butylphenol, 2,6-di-t-butyl-p-cresol and phenothiazine.

The range of the number average molecular weight of the polymer compound represented by formula (1) and obtained in above is preferably 11,000 to 300,000, more preferably 15,000 to 200,000. When the molecular weight is smaller than the range aforementioned, the adhesion to the low roughness copper foil sometimes becomes low. When the molecular weight is larger than the range aforementioned, the viscosity becomes high and coating and the like sometimes becomes difficult.

Note that the molecular weight in the present specification means the value calculated in terms of polystyrene based on the GPC measurement results.

The resin composition of the present invention contains at least one selected from a group consisting of a phenylmaleimide compound (A), an acenaphthylene compound (B), a modified polyphenylene ether resin having an unsaturated double bond at the end (C) and an aryl isocyanurate compound (D) as a compound radically polymerizable with the polymer compound represented by formula (1).

(A) Phenylmaleimide Compound (Described Simply as “Component (A)” Hereinafter)

The component (A) which the resin composition of the present invention can contain is added to copolymerize with the unsaturated double bond groups which the polymer compound represented by formula (1) has at the ends of the side chains. The number of the maleimide group in the compound is not particularly limited, but the phenylmaleimide compound having one maleimide group in one molecule is preferable.

Examples of the component (A) include N-phenylmaleimide, N-(2-methylphenyl)maleimide, N-(3-methylphenyl)maleimide, N-(4-methylphenyl)maleimide, N-(2,6-dimethylphenyl)maleimide, N-(4-t-butylphenyl)maleimide and N-phenylmaleimide is preferable.

The content of the component (A) in the resin composition of the present invention is generally 3 to 50 parts by mass, preferably 5 to 40 parts by mass based on 100 parts by mass of the polymer compound represented by formula (1). By making the content ratio of the polymer compound represented by formula (1) and the component (A) within the range described the above, the excellent properties of the cured product of the resin composition of the present invention are exhibited.

(B) Acenaphthylene Compound (Described Simply as “Component (B)” Hereinafter)

The component (B) which the resin composition of the present invention can contain is added to copolymerize with the unsaturated double bond groups which the polymer compound represented by formula (1) has at the ends of the side chains. The number of the acenaphthylene structure in the compound is not particularly limited, but the acenaphthylene compound having one acenaphthylene structure in one molecule is preferable.

Examples of the component (B) include acenaphthylene, 3-methylacenaphthylene, 4-methylacenaphthylene, 5-methylacenaphthylene, 3,8-dimethylacenaphthylene, 3,7-dimethylacenaphthylene and acenaphthylene is preferable.

The content of the component (B) in the resin composition of the present invention is generally 3 to 50 parts by mass, preferably 5 to 40 parts by mass based on 100 parts by mass of the polymer compound represented by formula (1). By make the content ratio of the polymer compound represented by formula (1) and the component (B) within the range aforementioned the excellent properties of the cured product of the resin composition of the present invention are exhibited.

(C) Modified Polyphenylene Ether Resin Having an Unsaturated Double Bond at the End (Described Simply as “Component (C)” Hereinafter)

As the component (C) which the resin composition of the present invention can contain the modified polyphenylene ether resin having methacryloyl group, acryloyl group or vinyl group at both ends of the molecule and a number average molecular weight of 1000 to 10000 are preferable. Examples include the compound represented by following formula (3) and having methacryloyl groups at both ends and a number average molecular weight of about 1700 (product name SA9000 manufactured by SABIC Japan LLC) or the compound represented by following formula (4) and having vinyl groups at both ends and a number average molecular weight of about 1200 or 2200 (product name OPE-2St 1200 or OPE-2St 2200 manufactured by MITSUBISHI GAS CHEMICAL COMPANY, INC.).

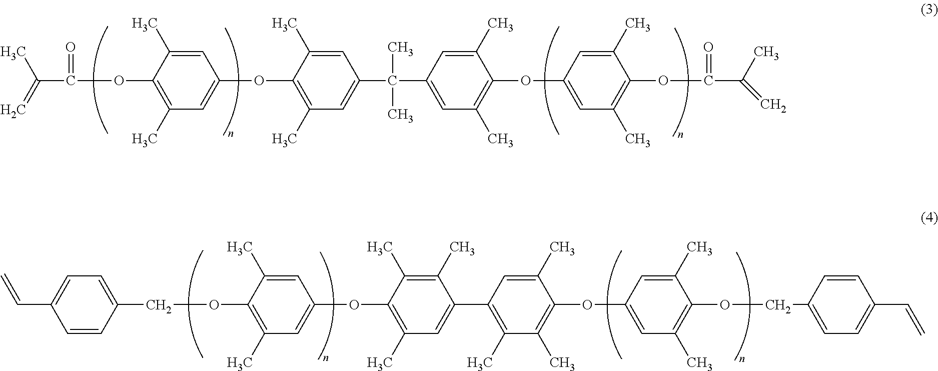

The content of the component (C) in the resin composition of the present invention is generally 3 to 50 parts by mass, preferably 5 to 40 parts by mass based on 100 parts by mass of the polymer compound represented by formula (1).

(D) Aryl Isocyanurate Compound (Described Simply as “Component (D)” Hereinafter)

The component (D) which the resin composition of the present invention can contain is preferably aryl isocyanurate compound having the isocyanurate structure and not less than two aryl groups in one molecule and includes triaryl isocyanurate, 1,3-diaryl-5-methoxycarbonyl-1,3,5-triazine-2,4,6(1H,3H,5H)-trione and 1,3-diaryl-5-(cyclohexene-4-yl)methoxycarbonyl-1,3,5-triazine-2,4,6(1H,3H,5H)-trione. One example of the aryl isocyanurate compound having two aryl groups includes L-DAIC manufactured by SHIKOKU CHEMICALS CORPORATION.

Note that the monoaryl isocyanurate compound having the functional group capable of reacting with the polymer compound represented by formula (1) except for aryl group are also contained in the category of the component (D) contained in the resin composition of the present invention.

The content of the component (D) in the resin composition of the present invention is generally 3 to 50 parts by mass, preferably 5 to 40 parts by mass based on 100 parts by mass of the polymer compound represented by formula (1). By making the content of the component (D) based on the polymer compound represented by formula (1) within the range aforementioned the excellent properties of the cured product of the resin composition of the present invention are exhibited.

The resin composition of the present invention contains the radical initiator. Both of the thermal radical initiator and the photo radical initiator can be used as the radical initiator.

Examples of the preferable thermal radical initiator include a peroxide such as benzoylperoxide, cumenehydroperoxide, 2,5-dimethylhexane-2,5-dihydroperoxide, 2,5-dimethyl-2,5-di(t-butylperoxy)hexyne-3, di-t-butylperoxide, t-butylcumylperoxide, α,α-bis(t-butylperoxy-m-isopropyl)benzene, 2,5-dimethyl-2,5-di(t-butylperoxy)hexane, dicumylperoxide, di-t-butylperoxyisophthalate, t-butylperoxybenzoate, 2,2-bis(t-butylperoxy)butane, 2,2-bis(t-butylperoxy)octane, 2,5-dimethyl-2,5-di(benzoylperoxy)hexane, di(trimethylsilyl)peroxide and trimethylsilyltriphenylsilylperoxide.

Examples of the preferable photo radical initiator include benzoin and alkyl ether thereof such as benzoin, benzoin methyl ether and benzoin ethyl ether; acetophenone such as acetophenone, 2,2-dimethoxy-2-phenylacetophenone and 1,1-dichloroacetophenone; anthraquinone such as 2-methylanthraquinone, 2-amylanthraquinone, 2-t-butylanthraquinone and 1-chloroanthraquinone; thioxanthone such as 2,4-dimethylthioxanthone, 2,4-diisopropylthioxanthone and 2-chlorothioxanthone; ketal such as acetophenonedimethylketal and benzyldimethylketal; benzophenone such as benzophenone; 2-methyl-1-[4-(methylthio)phenyl]-2-morpholino-propane-1-one or 2-benzyl-2-dimethylamino-1-(4-morpholinophenyl)-butanone-1; acyl phosphineoxide and xanthone.

The content of the radical initiator in the resin composition of the present invention is generally 0.1 to 10 parts by mass, preferably 0.1 to 8 parts by mass based on 100 parts by mass of total of the resin components such as the polymer compound represented by formula (1), the compound radially polymerizable with the polymer compound represented by formula (1) and the radical-reactive monomer which is an optional component described below.

The radical-reactive monomer may be used together with the resin composition of the present invention. By using the radical-reactive monomer together reactivity of the resin composition of the present invention, heat resistance of the cured product and the like can be improved. The radical-reactive monomer having two or more functional groups is preferable. Examples of the radical-reactive monomer include ethyleneglycoldimethacrylate, diethyleneglycoldimethacrylate, triethyleneglycoldimethacrylate, 1,4-butanedioldimethacrylate, neopentylglycoldimethacrylate, 1,6-hexanedioldimethacrylate, 1,9-nonanedioldimethacrylate, glycerindimethacrylate, 2-hydroxy-3-acryloyloxypropylmethacrylate, ethyleneoxide adduct methacrylate of bisphenol A trimethylolpropanetrimethacrylate, tricyclodecanedimethanoldimethacrylate, glycerindimethacrylate, trimethylolpropanetrimethacrylate, ethoxylated isocyanuric acid triacrylate, ε-caprolactone-modified tris-(2-acryloxyethyl)isocyanurate, pentaerythritoltriacrylate, ditrimethylolpropanetetraacrylate, ethoxylated pentaerythritoltetraacrylate, pentaerythritoltetraacrylate, dipentaerythritolpolyacrylate, dipentaerythritolhexaacrylate, triallylisocyanurate, triallylcyanurate, divinylbenzene, divinyl isophthalate, N-phenyl-maleimide, N-phenyl-methylmaleimide, N-phenyl-chloromaleimide, N-p-chlorophenyl-maleimide, N-p-methoxyphenyl-maleimide, N-p-methylphenyl-maleimide, N-p-nitrophenyl-maleimide, N-p-phenoxyphenyl-maleimide, N-p-phenylaminophenyl-maleimide, N-p-phenoxycarbonylphenyl-maleimide, 1-maleimide-4-acetoxysuccinimide-benzene, 4-maleimide-4′-acetoxysuccinimide-diphenylmethane, 4-maleimide-4′-acetoxysuccinimide-diphenylether, 4-maleimide-4′-acetoamide-diphenylether, 2-maleimide-6-acetoamide-pyridine, 4-maleimide-4′-acetoamide-diphenylmethane, N-p-phenylcarbonylphenyl-maleimide, N-ethylmaleimide, N-2,6-xylylmaleimide, N-cyclohexylmaleimide, N-2,3-xylylmaleimide, xylylmaleimide, 2,6-xylenemaleimide and 4,4′-bismaleimidediphenylmethane. The compound having a maleimide group as a functional group (maleimide compound) is preferable.

These radical-reactive monomer may be used alone or in mixture of two or more.

The organic solvent may be used together with the resin composition of the present invention. Examples of the organic solvent include aromatic solvent such as toluene and xylene; ether solvent such as diethyleneglycoldimethylether, diethyleneglycoldiethylether, propyleneglycol, propyleneglycolmonomethylether, propyleneglycolmonomethylethermonoacetate and propyleneglycolmonobutylether; ketone solvent such as methylethylketone, methylisobutylketone, cyclopentanone and cyclohexanone; lactone such as γ-butyrolactone and γ-valerolactone; amide solvent such as N-methylpyrrolidone (NMP), N,N-dimethylformamide (DMF), N,N-dimethylacetoamide and N,N-dimethylimidazolidinone; sulfone such as tetramethylenesulfone. The content of the organic solvent in the resin composition of the present invention is generally not more than 90% by mass in the resin composition, preferably 30 to 80% by mass.

The polymerization inhibitor may be used together with the resin composition of the present invention to improve storage stability. The polymerization inhibitor usable together is not particularly limited as long as it is generally well-known. Examples include quinone such as hydroquinone, methylhydroquinone, p-benzoquinone, chloranil and trimethylquinone, aromatic diol, di-t-butylhydroxytoluene.

The resin composition of the present invention can be used by being blended with the filler and the additive as much as the original performance of the resin composition is not impaired for the purpose of giving the desired performance according to the application. The filler may be fibrous or powdery. Examples of the filler include silica, carbon black, alumina, talc, mica, glass beads and hollow glass sphere.

The flame-resistant compound, the additive and the like can be added to the resin composition of the present invention. These are not particularly limited as long as these are used generally. Examples of the flame-resistant compound include bromine compounds such as 4,4-dibromobiphenyl, phosphate ester, melamine phosphate, phosphorus-containing epoxy resin, nitrogen compound such as melamine and benzoguanamine, oxazine ring-containing compound and silicon compound. Examples of the additive include ultraviolet absorber, antioxidant, photopolymerization initiator, fluorescent brightening agent, photosensitizer, dyes, pigment, thickener, lubricant, defoaming agent, dispersant, leveling agent, brightener. The additive can be used in combination according to circumstance if so desired.

The resin composition of the present invention can be used by applying on various base materials or impregnating. For example, when the thermal radical initiator is used, the resin composition can be used as the interlayer insulation layer of the multilayer printed board by applying on the PET film, as the cover lay by applying on the polyimide film and as the copper foil with resin by drying after applying on the copper foil. The resin composition can be used as the printed wiring board and the CFRP prepreg by impregnating glass cloth or glass paper, carbon fiber, a variety of nonwoven fabric and the like with the resin composition. In addition, the resin composition can be used as a variety of resist by using the photo radical initiator.

The interlayer insulation layer and the cover lay, the copper foil with resin, the prepreg and the like containing the resin composition of the present invention can be made into the cured product by applying heat and pressure with the hot press machine and the like to form.

### EXAMPLES

The present invention will be explained in more detail with Examples and Comparative Examples hereinafter, but is not limit to these Examples.

### Synthesis Example 1 (Synthesis of Polymer Compound Represented by Formula (1))

### (Step 1) Synthesis of Copolymer Represented by Following Formula (5) (Copolymer 1)

Into the flask provided with a thermometer, a cooling pipe, an nitrogen introducing pipe and a stirring device, 38.5 parts of styrene, 1.5 parts of 4-hydroxyphenylmethacrylate, 0.4 parts of benzoyl peroxide and 10 parts of propyleneglycolmonomethyletheracetate (PGMEA) were added and reacted under nitrogen atmosphere at 120 to 130° C. for 5 hours to obtain the PGMEA solution of the copolymer 1 represented by following formula (5). A part of the PGMEA solution described above was heated under reduced pressure to remove the solvent and the unreacted styrene. The obtained mass amount of the copolymer 1 calculated by regarding the dry mass as a solid component amount was 34.2 parts. Considering that the unreacted styrene was 5.8 parts, the copolymer 1 obtained was the copolymer of 32.7 parts of styrene and 1.5 parts of 4-hydroxyphenylmethacrylate. The number average molecular weight of the sample subjected to the measurement of the dry mass aforementioned was 38,000 and the weight average molecular weight was 161,000. The n and m in formula (5) calculated from the copolymerization ratio of styrene and 4-hydroxyphenylmethacrylate and the number average molecular weight were 361 and 9, respectively.

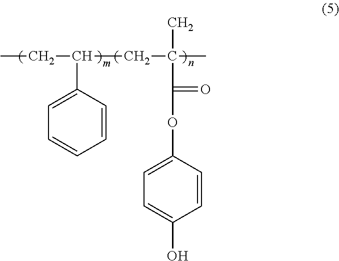

### (Step 2) Synthesis of Polymer Compound Represented by Following Formula (6) (Polymer Compound 1)

After distilling off the unreacted styrene and PGMEA under reduced pressure and heating from the PGMEA solution of the copolymer obtained in Step 1, PGMEA was added to obtain 138 parts of 25% by mass copolymer 1 solution. After 5 parts of triethylamine was added into the solution and the temperature of the solution was increased to 60° C. under stirring, in this state 0.88 parts of methacrylic acid chloride was added and reacted for 1 hour. The reaction liquid was filtered under pressure with the filter paper that can catch the particles of size of 1 μm to remove triethylamine hydrochloride. Excessive triethylamine and PGMEA were distilled off from the filtrate with the rotary evaporator. The amount of PGMEA was adjusted to obtain 139 parts of the solution containing 25% by mass of the polymer compound of the present invention represented by following formula (6) (polymer compound 1). The number average molecular weight of the polymer compound 1 obtained was 40,000 and the weight average molecular weight was 164,000.

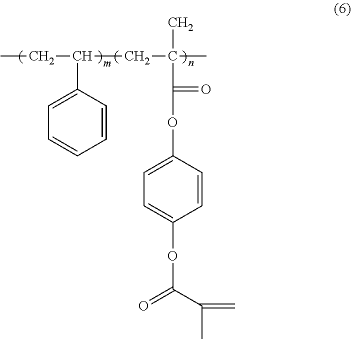

### Example 1 (Preparation of Resin Composition of Present Invention)

The resin composition 1 of the present invention was obtained by adding 0.05 parts of dicumylperoxide as a radical initiator and 1.1 parts of N-phenylmaleimide to 10 parts of the PGMEA solution of the polymer compound 1 obtained in Synthesis Example 1 and mixing homogenously.

### Example 2 (Preparation of Resin Composition of Present Invention)

The resin composition 2 of the present invention was obtained by adding 0.05 parts of dicumylperoxide as a radical initiator and 1.1 parts of acenaphthylene to 10 parts of the PGMEA solution of the polymer compound 1 obtained in Synthesis Example 1 and mixing homogenously.

### Example 3 (Preparation of Resin Composition of Present Invention)

The resin composition 3 of the present invention was obtained by adding 0.05 parts of dicumylperoxide as a radical initiator and 0.3 parts of modified polyphenylene ether resin (SA-9000) to 10 parts of the PGMEA solution of the polymer compound 1 obtained in Synthesis Example 1 and mixing homogenously.

### Example 4 (Preparation of Resin Composition of Present Invention)

The resin composition 4 of the present invention was obtained by adding 0.05 parts of dicumylperoxide as a radical initiator and 0.6 parts of modified polyphenylene ether resin (SA-9000) to 10 parts of the PGMEA solution of the polymer compound 1 obtained in Synthesis Example 1 and mixing homogenously.

### Example 5 (Preparation of Resin Composition of Present Invention)

The resin composition 5 of the present invention was obtained by adding 0.05 parts of dicumylperoxide as a radical initiator and 0.38 parts of L-DAIC (manufactured by SHIKOKU CHEMICALS CORPORATION) to 10 parts of the PGMEA solution of the polymer compound 1 obtained in Synthesis Example 1 and mixing homogenously.

### Example 6 (Preparation of Resin Composition of Present Invention)

The resin composition 6 of the present invention was obtained by adding 0.05 parts of dicumylperoxide as a radical initiator and 0.38 parts of triarylisocyanurate (manufactured by Mitsubishi Chemical Corporation) to 10 parts of the PGMEA solution of the polymer compound 1 obtained in Synthesis Example 1 and mixing homogenously.

### Comparative Example 1 (Preparation of Comparative Resin Composition)

The comparative resin composition 7 was obtained by adding 0.05 parts of dicumylperoxide as a radical initiator to 10 parts of the PGMEA solution of the polymer compound 1 obtained in Synthesis Example 1 and mixing homogenously.

(Evaluation of Dielectric Properties, Glass transition temperature and Linear Expansion Coefficient of Cured Product of Resin Composition)

The resin compositions 1 to 7 obtained in Examples 1 to 6 and Comparative Example 1 were applied on the mirror surfaces of the copper foils having a thickness of 18 μm for the applied film thickness to be 280 μm by using the applicator. The copper foil having film adhesive of the resin composition was obtained by heating the resin composition at 90° C. for 10 minutes to dry the solvent. The film adhesives on the copper foils obtained above were cured by heating at 180° C. for 1 hour in the vacuum oven. Then the cured products of the film adhesives with a thickness of 70 μm which can be handled as a film were obtained by removing the copper foils by soaking the film adhesives on the copper foils in the etchant. The values of dielectric constant and dielectric loss tangent of the cured products obtained the above at 10 GHz were measured by using Network analyzer 8719ET (manufactured by Agilent Technologies Japan, Ltd.) by the cavity resonance method. The glass transition temperature and alpha 1(α1, the linear expansion coefficient in the glassy region) were measured by using TMA (Thermomechanical Analyzer). The results were shown in Table 1.

(Evaluation of Adhesive Strength of Cured Product of Resin Composition)

The resin compositions 1 to 7 obtained in Examples 1 to 6 and Comparative Example 1 were applied on the matted surface of the high frequency low roughness copper foil with a thickness of 12 μm (CF-T4X-SV: manufactured by FUKUDA METAL FOIL and POWDER Co., Ltd.) by using the applicator for the applied film thickness to be 50 μm. The copper foils having film adhesives of the resin compositions of the present invention were obtained by heating the resin compositions at 90° C. for 10 minutes to dry the solvent. Onto the adhesive application surfaces of the copper foils with the resins obtained above, the matted surface of the same copper foil as above was put and the resin compositions were cured by heating with the pressure of 3 MPa in vacuum for 1 hour. Then the values of the 90° peeling strength between the copper foils (adhesive strength) were measured by using Autograph AGX-50 (manufactured by Shimazu Corporation). The results were shown in Table 1.

TABLE 1
Evaluation results of cured product of resin composition

| | Example | Example | Example | Example | Example | Example | Comparative |
|---|---|---|---|---|---|---|---|
| Resin composition | 1 | 2 | 3 | 4 | 5 | 6 | Example 1 |
| Dielectric constant [10 GHz] | 2.50 | 2.43 | 2.45 | 2.48 | 2.34 | 2.38 | 2.40 |
| Dielectric loss tangent [10 GHz] | 0.00128 | 0.00130 | 0.00125 | 0.00138 | 0.0008 | 0.0010 | 0.0011 |
| Glass transition temperature [° C.] | 123 | 121 | 120 | 124 | 110 | 115 | 108 |
| α1 [ppm/° C.] | 65 | 70 | 79 | 73 | 85 | 75 | 100 |
| Adhesive strength [N/mm] | 0.55 | 0.50 | 0.65 | 0.64 | 0.55 | 0.50 | 0.65 |

AS seen in the above the cured products of the resin compositions of the present invention were formed into the flexible films and furthermore exhibited excellent dielectric properties, heat resistance and adhesion.

1. A resin composition comprising a polymer compound represented by following formula (1): 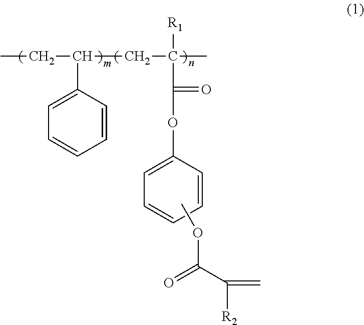
wherein in the formula (1), R₁ and R₂ each independently represent a hydrogen atom or a methyl group, m and n are average numbers of repeating units, and each independently are within a range of 1 to 2,000, a compound radically polymerizable with the polymer compound and a radical polymerization initiator,
wherein the compound radically polymerizable with the polymer compound is at least one selected from a group consisting of a phenylmaleimide compound, an acenaphthylene compound, a modified polyphenylene ether resin having an unsaturated double bond at an end, and an aryl isocyanurate compound.

2. The resin composition according to claim 1, wherein the compound radically polymerizable with the polymer compound is a phenylmaleimide compound having a maleimide group in one molecule or a compound having an acenaphthylene structure in one molecule.

3. A film adhesive of the resin composition according to claim 1.

4. A cured product of the resin composition according to claim 1.
